(19) United States
(12) Patent Application Publication
(10) Pub. No.: US 2023/0177038 A1
(43) Pub. Date: Jun. 8, 2023

(54) DECISION-BASED SEQUENTIAL REPORT GENERATION

(71) Applicant: Salesforce.com, Inc., San Francisco, CA (US)

(72) Inventors: Keye LIU, San Francisco, CA (US); Puneet DHALIWAL, Hayward, CA (US); Dai Duong DOAN, Alameda, CA (US); Tyler SHOPSHIRE, San Francisco, CA (US); Angela LIU, San Francisco, CA (US)

(73) Assignee: Salesforce.com, Inc., San Francisco, CA (US)

(21) Appl. No.: 17/643,388

(22) Filed: Dec. 8, 2021

(51) Int. Cl. G06F 16/23; G06F 16/22; G06F 16/93; G06F 11/30

(52) U.S. Cl. CPC G06F 16/23; G06F 11/3086; G06F 16/93; G06F 16/2272

(57) ABSTRACT

Disclosed are some implementations of systems, apparatus, methods and computer program products for performing a decision-based multi-stage report generation process. Execution of a set of computer-readable instructions configurable to generate a report is initiated. During execution of a first subset of the set of computer-readable instructions associated with a first stage of report generation, at least a first template is applied. A result of the first stage of report generation is ascertained. It is determined whether the first stage of report generation is successfully completed based, at least in part, on application of a first condition to the result of the first stage of report generation. A first indicator of a data structure associated with the set of computer-readable instructions is updated such that the first indicator indicates whether the first stage of report generation is successfully completed. Execution of a second subset of the set of computer-readable instructions associated with a second stage of the report generation is initiated based, at least in part, on a value of the first indicator. During the second stage of report generation, at least a portion of a first report is generated using at least a second template.

### COPYRIGHT NOTICE

A portion of the disclosure of this patent document contains material, which is subject to copyright protection. The copyright owner has no objection to the facsimile reproduction by anyone of the patent document or the patent disclosure as it appears in the United States Patent and Trademark Office patent file or records but otherwise reserves all copyright rights whatsoever.

### TECHNICAL FIELD

This patent document generally relates to systems and techniques for automatically generating reports. More specifically, this patent document discloses techniques for performing decision-based report generation.

### BACKGROUND

A report generator is a computer program that typically obtains data from a data source such as a data stream, database, or spreadsheet and generates a report by presenting the data in a pre-defined format. By eliminating the need for manual report generation, the likelihood of errors being introduced during report generation is substantially reduced. Once generated, the report can be presented for viewing online or exported to a file that can be stored for subsequent retrieval.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The included drawings are for illustrative purposes and serve only to provide examples of possible structures and operations for the disclosed systems, apparatus, methods and computer program products for facilitating implementation of a report generation system. These drawings in no way limit any changes in form and detail that may be made by one skilled in the art without departing from the spirit and scope of the disclosed implementations.

FIG. 1 shows a system diagram of an example of a system 100 in which decision-based sequential report generation can be implemented, in accordance with some implementations.

FIG. 2A shows a process flow diagram 200 illustrating an example method of implementing a first portion of a multi-stage decision-based report generation process, in accordance with some implementations.

FIG. 2B shows a process flow diagram 250 illustrating an example method of implementing a second portion of a multi-stage decision-based report generation process, in accordance with some implementations.

FIG. 3 shows an example report generation object 300 that may be maintained in association with a multi-stage decision-based report generation process, in accordance with some implementations.

FIG. 4A shows a process flow diagram 400 illustrating a method of implementing a multi-stage decision-based report generation process, in accordance with various implementations.

FIG. 4B shows a process flow diagram 450 illustrating a method of generating an additional report or portion thereof during a multi-stage decision-based report generation process, in accordance with various implementations.

FIG. 5 shows a process flow diagram 404 illustrating a method of obtaining signatures during a portion of a multi-stage decision-based report generation process in accordance with various implementations.

FIG. 6A shows a block diagram of an example of an environment 10 in which an on-demand database service can be used in accordance with some implementations.

FIG. 6B shows a block diagram of an example of some implementations of elements of FIG. 6A and various possible interconnections between these elements.

FIG. 7A shows a system diagram of an example of architectural components of an on-demand database service environment 900, in accordance with some implementations.

FIG. 7B shows a system diagram further illustrating an example of architectural components of an on-demand database service environment, in accordance with some implementations.

### DETAILED DESCRIPTION

Examples of systems, apparatus, methods and computer program products according to the disclosed implementations are described in this section. These examples are being provided solely to add context and aid in the understanding of the disclosed implementations. It will thus be apparent to one skilled in the art that implementations may be practiced without some or all of these specific details. In other instances, certain operations have not been described in detail to avoid unnecessarily obscuring implementations. Other applications are possible, such that the following examples should not be taken as definitive or limiting either in scope or setting.

In the following detailed description, references are made to the accompanying drawings, which form a part of the description and in which are shown, by way of illustration, specific implementations. Although these implementations are described in sufficient detail to enable one skilled in the art to practice the disclosed implementations, it is understood that these examples are not limiting, such that other implementations may be used and changes may be made without departing from their spirit and scope. For example, the operations of methods shown and described herein are not necessarily performed in the order indicated. It should also be understood that the methods may include more or fewer operations than are indicated. In some implementations, operations described herein as separate operations may be combined. Conversely, what may be described herein as a single operation may be implemented in multiple operations.

Some implementations of the disclosed systems, apparatus, methods and computer program products are configured to implement an automated multi-stage decision-based report generation system. In some implementations, systems, apparatus, methods, and computer program products are configured to obtain signatures during a first stage of an automated report generation process and generate, during a second stage of the report-generation process, at least a portion of a report based on a result of the first stage.

Today, report generation can be a valuable tool for gathering and presenting data in a format that is most useful to a given business. This is typically accomplished by generating a computer program that is configured to gather data from specific data sources and present the data in a pre-defined format. Unfortunately, currently available report generation tools have a number of limitations

Typically, data is extracted from pre-defined data sources and a report including the extracted data is generated using a single, static, pre-defined template. As a result, conventional report generation is designed to apply the same static template to a wide variety of scenarios. Therefore, the ability to customize the report generation process is generally limited to the creation of a new template.

In accordance with various implementations, report generation can be accomplished in multiple stages. A template applied during one stage may differ from that applied during another stage. During report generation, a template can be applied for a variety of purposes including, but not limited to, obtaining data (e.g., a signature or survey), generating a portion of a report, or generating a complete report. Therefore, a single report generation process can generate one or more reports using any number of templates.

In some implementations, multi-stage decision-based report generation is facilitated by maintaining and updating a report generation object throughout the stages of report generation. A report generation object can include a data structure that maintains stage information indicating a current stage of report generation, as well as other metadata pertaining to report generation. The report generation object can also include data obtained during stage(s) of report generation. For example, the report generation object can include signature(s) obtained during a stage of report generation. The report generation object can be passed from one stage to another via an application programming interface (API).

In some implementations, during a report generation stage, data can be obtained from one or more sources. A source can include a conventional data source such a data stream, storage medium, or table. Alternatively, the source can include an individual such as a recipient of a message transmitted during a report generation stage. For example, the message can include a survey or a signature document.

In accordance with various implementations, report generation is a dynamic conditional decision-based process. In some implementations, progression from one report generation stage to another is determined based, at least in part, on application of at least one condition to a result of a prior report generation stage. The condition can govern whether report generation progresses to a subsequent stage. Alternatively, the condition can govern which of two or more stages is to be traversed.

A condition can determine whether completion of a previous report generation stage was successful. For example, a condition can determine whether signatures have been obtained from all recipients of a signature document request. As another example, a condition can determine whether signatures have been obtained from a threshold number of the recipients.

In some implementations, a condition may be applied to data obtained during a previous stage or a result of analysis of the data. For example, a condition may be applied to a result of analysis of data obtained as a result of a survey completed by a recipient of a survey completion request message transmitted during a previous report generation stage.

In some implementations, a condition can dictate the timing with which report generation progresses to a subsequent report generation stage. This can be accomplished through the use of a timer and a timing threshold. For example, a condition can dictate that the report generation process proceed after a threshold time has elapsed even if all of the requested signatures have not been obtained.

In some implementations, a condition can dictate whether a field of a template is used to generate a report. A condition can be applied to a variety of values including, but not limited, to information obtained from a user profile. For example, the language spoken by a user accessing or receiving a report or message may be used to determine which fields of a report template to be displayed in the report/message.

In accordance with some implementations, a multi-stage decision-based report generator is customizable. In some implementations, customization can be accomplished via input submitted via a graphical user interface (GUI). Customization can include, but is not limited to, specification of condition(s), operation(s) performed during a stage of report generation, the order in which the operations are to be performed, and/or the order in which stages are to be performed. In addition, customization can include the selection of a template to be applied during a report generation stage. Therefore, a report generator can be customized for a variety of purposes by organizations, as well as customers of those organizations.

In some implementations customization can be accomplished via a visual process flow builder that enables a process flow to be designed via a drag-and-drop process. A process flow representing a report generation process can include a plurality of interconnected nodes representing computer modules or sub-flows. Input and output parameters associated with nodes can similarly be customized.

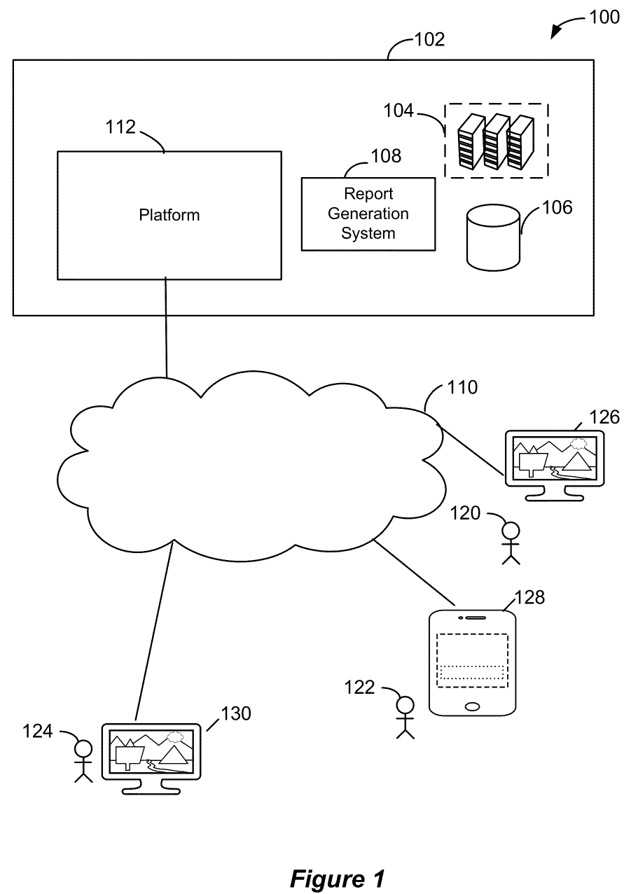

FIG. 1 shows a system diagram of an example of a system 100 in which a web-to-print methods can be implemented, in accordance with some implementations. Database system 102 includes a variety of different hardware and/or software components that are in communication with each other. In the non-limiting example of FIG. 1, system 102 includes any number of computing devices such as servers 104. Servers 104 can include one or more web servers configurable to execute web applications. Servers 104 are in communication with one or more storage mediums 106 configured to store and maintain relevant data and/or metadata used to perform some of the techniques disclosed herein, as well as to store and maintain relevant data and/or metadata generated by the techniques disclosed herein. Storage mediums 106 may further store computer-readable instructions configured to perform some of the techniques described herein. Storage mediums 106 can also store user accounts/user profiles of users of system 100, as well as database records such as customer relationship management (CRM) records.

System 102 includes server system 108, as described herein. More particularly, report generation system 108 supports the generation of reports, which can include data retrieved from database records or data obtained from other sources. A report can include a web document, a file, electronic mail (email) message, or other form of document or message. Report generation system 108 can initiate the generation of a report automatically or in response to a request received from a client device.

In some implementations, system 102 is configured to store user profiles/user accounts associated with users of system 102. Information maintained in a user profile of a user can include a client identifier such an Internet Protocol (IP) address or Media Access Control (MAC) address. In addition, the information can include a unique user identifier such as an alpha-numerical identifier, the user’s name, a user email address, and credentials of the user. Credentials of the user can include a username and password. The information can further include job related information such as a job title, role, group, department, organization, and/or experience level, as well as any associated permissions. Profile information such as job related information and any associated permissions can be applied by system 102 to manage access to web applications or services such as those described herein.

Client devices 126, 128, 130 may be in communication with system 102 via network 110. More particularly, client devices 126, 128, 130 may communicate with servers 104 via network 110. For example, network 110 can be the Internet. In another example, network 110 comprises one or more local area networks (LAN) in communication with one or more wide area networks (WAN) such as the Internet.

Embodiments described herein are often implemented in a cloud computing environment, in which network 110, servers 104, and possible additional apparatus and systems such as multi-tenant databases may all be considered part of the “cloud.” Servers 104 may be associated with a network domain, such as www.salesforce.com and may be controlled by a data provider associated with the network domain. In this example, employee users 120, 122, 124 of client computing devices 126, 128, 130 have accounts at salesforce.com®. By logging into their accounts, users 126, 128, 130 can access the various services and data provided by system 102 to employees. In other implementations, users 120, 122, 124 need not be employees of salesforce.com® or log into accounts to access services and data provided by system 102. Examples of devices used by users include, but are not limited to, a desktop computer or portable electronic device such as a smartphone, a tablet, a laptop, a wearable device such as Google Glass®, another optical head-mounted display (OHMD) device, a smart watch, etc.

In some implementations, users 120, 122, 124 of client devices 126, 128, 130 can access services provided by system 102 via platform 112 or an application installed on client devices 126, 128, 130. More particularly, client devices 126, 128, 130 can log into system 102 via an application programming interface (API) or via a graphical user interface (GUI) using credentials of corresponding users 120, 122, 124 respectively. Client devices 126, 128, 130 can communicate with system 102 via platform 112. Communications between client devices 126, 128, 130 and system 102 can be initiated by a user 120, 122, 124. Alternatively, communications can be initiated by system 102 and/or application(s) installed on client devices 126, 128, 130. Therefore, communications between client devices 126, 128, 130 and system 102 can be initiated automatically or responsive to a user request.

Client devices 126, 128, 130 can be operated by various users of system 102. In some instances, a client device can be operated by a user configuring operation of report generation system 108 or a user requesting generation of a report by report generation system 108. In other instances, a client device can be operated by a user that receives a request for user response during a stage of report generation. For example, the request can include a user survey or signature document request. In yet other instances, a client device can be operated by a user that receives a report generated by report generation system.

Some implementations may be described in the general context of computing system executable instructions, such as program modules, being executed by a computer. The disclosed implementations may further include objects, data structures, and/or metadata, which may facilitate the implementation of an intent driven system, as described herein.

Some implementations may also be practiced in distributed computing environments where tasks are performed by remote processing devices that are linked through a communications network. In a distributed computing environment, program modules may be located in local and/or remote computer storage media including memory storage devices.

Report generation system 108 is configurable. Configuration can be accomplished by an administrator or other user. Configuration can include configuration of a condition to be applied during report generation. For example, configuration of a condition can include specification or selection of operator(s) and/or operand(s). An operand can include, for example, a result from a prior stage. A result from a prior stage can include, for example, whether the previous stage was successfully completed, the number of recipients that have responded to a request (e.g., for signature or survey response), content of recipient response(s) (e.g., survey results) or analysis thereof, or other data and/or metadata that has been obtained.

Configuration can also include configuration of operations performed during any of the report stages. For example, configuration of operations performed during a report generation stage can include selecting the operations to be performed during a stage, any input parameters, any output parameters, and order of the operations.

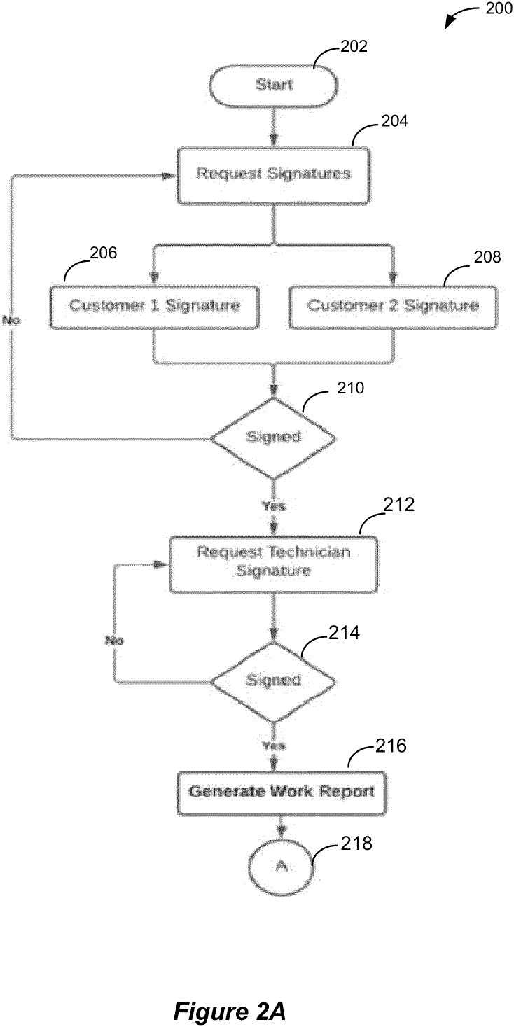

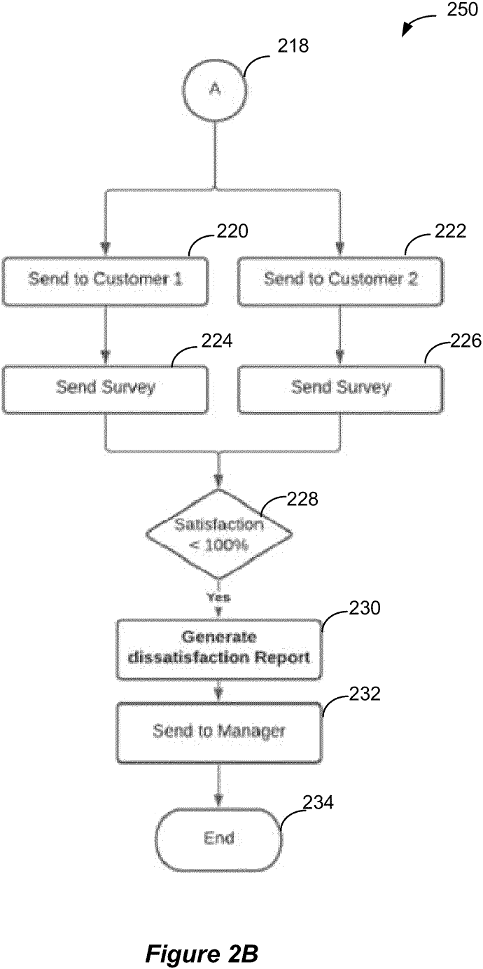

FIG. 2A shows a process flow diagram 200 illustrating an example method of implementing a first portion of a multi-stage decision-based report generation process, in accordance with some implementations. The report generation process starts at 202 and a signature request process begins at 204.

In the example of FIG. 2A, the system requests signatures from customers of a field service appointment pertaining to a work order serviced by a technician at an on-site location. More particularly, during the signature request process, the system requests that two different individuals, Customer 1 and Customer 2, sign a signature document such as a work order, as shown at 206, 208, respectively. For example, the system may transmit a signature document request to each of the individuals via a network. The signature document request can be generated via a first template. For example, the first template can include a message template via which a message transmitted to the individuals is generated. As another example, the first template can include a signature document template used to generate a signature document that is to be signed by the individual(s). The signature document request can include a link via which a signature document can be accessed and signed electronically using a stylus or other input mechanism. Alternatively, the signature document request can notify the individual(s) that the signature document can be accessed via another application or platform. Upon signing the document, the signature(s) and/or signed signature document can be stored (e.g., in a storage medium or report generation object). In some instances, where the signature document is accessed and signed via another application or platform, a notification message indicating that the signature document has been signed can be received from the application or platform. For example, such a notification message can be received via an API.

One or more conditions may be applied prior to progression to a subsequent report generation stage at which a report or portion thereof is generated. In this example, the system applies a first condition to determine whether the individuals have signed the signature document at 210. Upon determining that the individuals have both signed the signature document, the system proceeds at 212 to transmit a signature document request to the technician. The system applies a second condition to determine whether the technician has signed the document and does not proceed until the technician also signs the signature document. In this manner, the technician is asked to sign off on the work order after the system has verified that the customers have signed off on the work order,

Upon determining that the customers and technician have also signed the signature document at 214, the system proceeds to generate a work report pertaining to the completed work order at 216.

Generation of a work report can include the application of a report template. The work report can include the signatures obtained from the customers and technician. The report generation process continues to proceed with a subsequent stage of report generation at A 218, as described in further detail below with reference to FIG. 2B.

FIG. 2B shows a process flow diagram 250 illustrating an example method of implementing a second portion of a multi-stage decision-based report generation process, in accordance with some implementations. During a subsequent stage, the process continues at 218 to obtain feedback from the customers. More particularly, the report generation process transmits survey requests to the customers at 220, 222 and obtains their completed surveys at 224, 226.

The system applies a condition at 228 to determine, based on data gathered from the surveys, whether the customers were satisfied with the results of the on-site service performed by the technician. More particularly, the system determines whether the customers were less than 100 percent satisfied with the service that they received.

The system proceeds with generation of a dissatisfaction report at 230 based upon the results of application of the condition. For example, if the system determines that the customers were 89 percent satisfied with the results of the service they received, the system generates the dissatisfaction report. The system then sends the report to a manager at 232. The report generation process ends at 234.

In accordance with various implementations, a report generation object is maintained in association with a report generation process. The report generation object can be updated throughout the report generation process to ensure that it reflects the current state of the report generation process. In addition, the report generation object can be stored by the system in the event that the report generation process is paused and can be retrieved by the system upon resuming the report generation process.

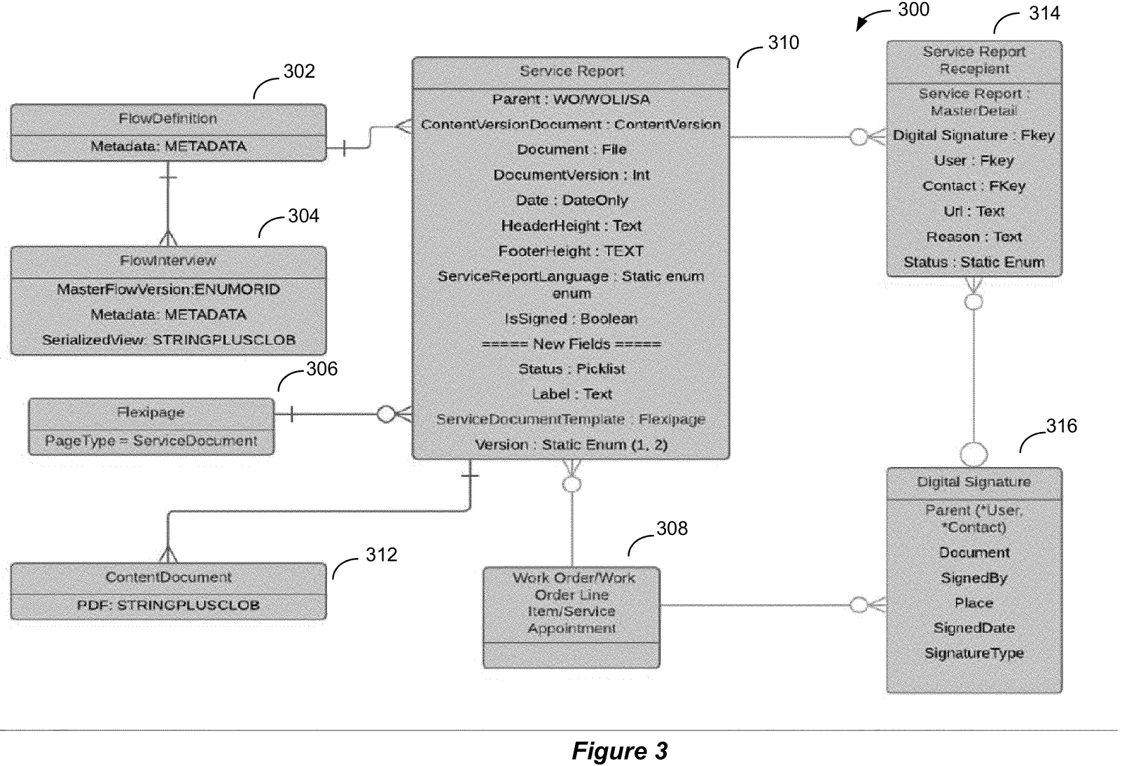

FIG. 3 shows an example report generation object 300 that may be maintained in association with a multi-stage decision-based report generation process, in accordance with some implementations. Report generation object 300 can include one or more data structures. Report generation object 300 can include an object instantiated in an object orientated language. In some implementations, report generation object 300 includes one or more records stored in one or more tables of a relational database.

Report generation object 300 stores metadata related to a report generation process. In addition, report generation object 300 can include data gathered during the report generation process.

In this example, report generation object 300 pertains to the fulfillment of a work order in a field service context. However, it is important to note that this example is merely illustrative. Therefore, report generation object 300 is configurable to store metadata and/or data pertaining to a variety of report generation processes.

As shown in FIG. 3, report generation object 300 can identify a flow definition 302, which identifies a process flow is executable to perform a report generation process such as that described herein. A flow definition can include a set of computer-readable instructions, which may correspond to a schema represented by a tree data structure. The report generation process can be initiated by deploying the process flow identified by flow definition 302.

Report generation object 300 can further identify a flow interview 304, which is a running instance of the process flow. Thus, flow interview 304 identifies a specific instance of the report generation process executed by the process flow.

In addition, report generation object 300 can identify a template 306 that is to be applied to generate a report. This enables the template used to generate a report to be specified without modifying the process flow that is used to guide the report generation process. Therefore, a single process flow can be executed to generate a number of different report formats.

In some implementations, report generation object 300 can identify a parent object or parent record 308 that is to be accessed by the report generation process. In this example, parent record 308 identifies a work order from which data is to be accessed for generation of the report. As shown in this example, a work order can include a line item, as well as other information such as a service appointment time. Data can be retrieved from a parent object/record 308 for a variety of purposes including, but not limited to, providing data for a field of a template or providing an operand for a condition that is applied, as described herein.

Report generation object 300 can further include a service report 310. Service report 310 can include a content document 312, where the content document 312 is a generated report that can be viewed or stored for subsequent retrieval. For example, the generated report can include an image, text, a Portable Document Format (PDF) document, a web document, and/or other type of document or message.

Service report 310 can include data and/or metadata gathered during one or more stages of the report generation process. More particularly, service report 310 can identify a status or stage of report generation, enabling report generation to resume at a later time in the event that report generation has been paused or there has been a delay. In addition, the status or stage can be accessed during a stage of report generation to determine the next stage or action. For example the status can indicate whether a report has been generated or transmitted to the recipient(s).

Service report 310 can also identify or otherwise indicate a language in which the report is to be generated, as well as identify one or more recipient(s) who are to receive the generated report or other documents such as signature documents or surveys. In some implementations, service report 310 can indicate whether the report has been signed by the recipients of the generated report or whether other documents (e.g., signature documents) have been signed. For example, documents used to generate the report or accompanying the report may require signatures while the report itself may not.

Status report 310 can further include a version identifier indicating a version of the report. Therefore, each time an instance of the report is generated, a version number can be incremented and stored in the version identifier.

Service report recipient entity 314 of report generation object 300 may identify a recipient that is to receive a message or request such as a signature request or a survey request. Alternatively, service report recipient entity 314 of report generation object 300 may identify a recipient that is to receive the final generated report. Service report recipient entity 314 may further identify a user or contact record associated with the recipient from which contact information such as an email address can be obtained for use in transmitting a request, report, or other message to the recipient. In some implementations, service report recipient entity 314 may indicate or identify a reason for obtaining a signature (e.g., credit check or mortgage application) or other response from the recipient. In addition, additional information such as a Uniform Resource Locator (URL) associated with the recipient may be identified.

In some implementations, report generation object 300 can include or reference data obtained from one or more individuals during a stage of the report generation process, as well as any metadata related to the data. In this example, report generation object 300 includes a signature entity 316, which can include digital signature(s) and attributes of individual(s) corresponding to the digital signature(s). The attributes of the individuals can include, for example, the name and/or title of the individuals from whom the digital signature(s) were obtained. Signature entity 316 can also identify or otherwise reference a parent record (e.g., Contact record or User record) having the attributes of the individuals. In addition, signature entity 316 can include, for one or more signatures, the date of signature and/or place of signature. Signature entity 316 can also indicate a type of digital signature that is stored in signature entity 316.

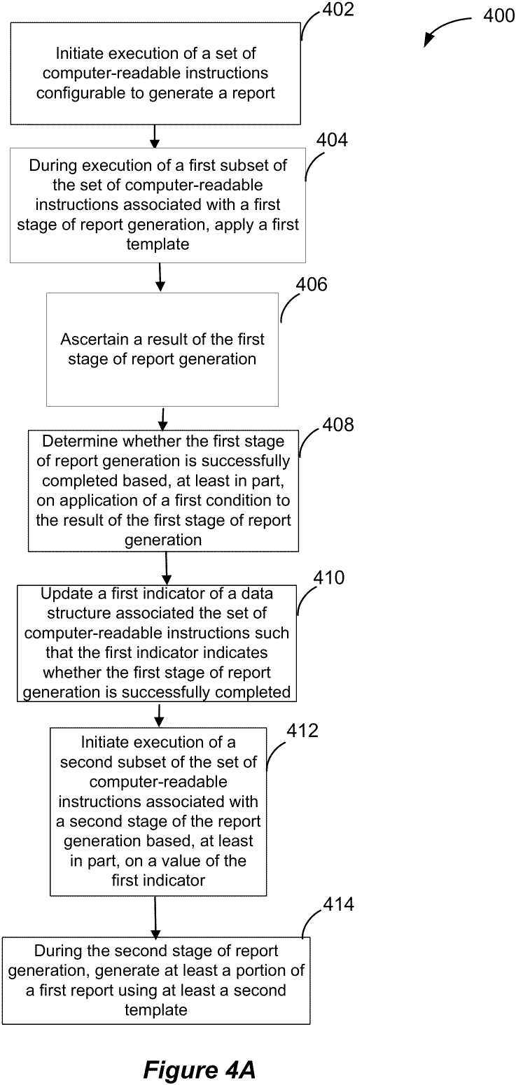

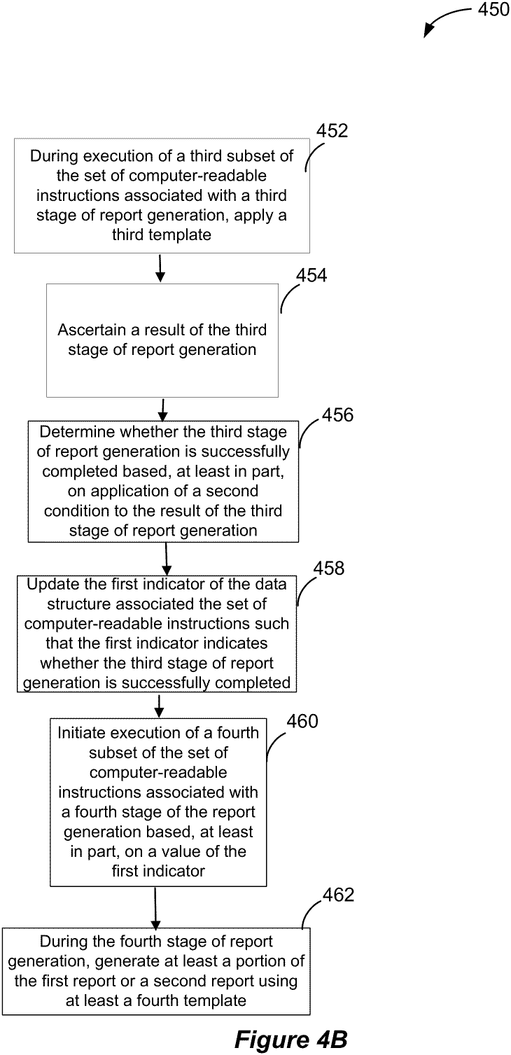

FIG. 4A shows a process flow diagram 400 illustrating a method of implementing a multi-stage decision-based report generation process, in accordance with various implementations. A report generation system initiates execution of a set of computer-readable instructions configurable to generate a report at 402. In some implementations, report generation is performed in real-time.

During execution of a first subset of the set of computer-readable instructions associated with a first stage of report generation, the system can apply at least a first template at 404. The first template can include, for example, a database query template, an email template, a customer survey template, a signature document template, or a report generation template. Application of the first template can include, but is not limited to, generating a report or portion thereof, transmitting a communication generated using the first template to one or more recipients (e.g., individuals), retrieving information (e.g., data) using the first template, and/or storing information generated by the first template.

A communication can be transmitted via text, email, or an API of an independent system (e.g., signature document system or survey system). The communication transmitted to a recipient can request a response such as a signature document or survey.

The system ascertains a result of the first stage of report generation at 406. The result can include data and/or metadata extracted or otherwise obtained from one or more sources during the first stage of report generation. In some implementations, the result can include one or more data objects (e.g., surveys or signed documents) or data, which can be obtained from one or more fields of database records or from an external source via an API. For example, data associated with the intended recipient of the report may be retrieved from a record associated with the recipient (e.g., user or contact record) to determine their native language or role within an organization. The result can also include analysis of the data and/or metadata.

For example, the system may ascertain whether requested responses or requested documents (e.g., signatures or surveys) have been provided by the recipients. As another example, the system may obtain and/or analyze content provided in the requested responses or documents.

The system determines whether the first stage of report generation is successfully completed at 408 based, at least in part, on application of at least a first condition to the result of the first stage of report generation. For example, the first condition may determine whether responses (e.g., signatures or surveys) have been received from the recipients. As another example, the first condition may determine whether the number of the responses (e.g., signatures or surveys) exceeds a completion threshold. As yet another example, the first condition may determine whether the quality of the responses (e.g., percentage satisfaction or percentage completion) exceeds (or does not exceed) a threshold.

A first indicator of a data structure associated the set of computer-readable instructions may be updated at 410 such that the first indicator indicates whether the first stage of report generation is successfully completed. For example, the first indicator may include a current status or stage of completion or, alternatively, may indicate that the previous (e.g., first) stage has completed executing. As another example, the first indicator may indicate whether signature(s) or survey responses have been obtained from recipient(s), as discussed above. As another example, the first indicator may indicate the number of responses (e.g., signatures), quality of the responses (e.g., percentage satisfaction, or whether the number or percentage exceeds (or does not exceed) a threshold.

In some implementations, upon completion of the first stage of report generation, the data structure is passed (e.g., by the currently executing stage) to a subsequent stage of the report generation. For example, the data structure may be provided by the first subset of the set of computer-readable instructions via an API corresponding to a second subset of the set of computer-readable instructions. As described herein, the data structure may include a stage identifier identifying a stage of the report generation. The stage may be useful, for example, for a sub-flow to determine which parent flow called the sub-flow or to determine which child flow it should call.

Execution of a second subset of the set of computer-readable instructions associated with a second stage of the report generation may be initiated at 412 based, at least in part, on a value of the first indicator. For example, the second stage of report generation may proceed if it is determined that the first stage has completed executing. As another example, the second stage of the report generation may proceed if it is determined that the requested signatures or survey results have been received from the recipients. As yet another example, the second stage of the report generation may proceed if it is determined that the number of signatures or survey results received exceed (or do not exceed) a specific threshold.

During the second stage of report generation, the system generates at least a portion of a first report using at least a second template at 414. In some implementations, the system generates at least a portion of the first report based, at least in part, on the first indicator in the first data structure, other information in the first data structure, or other result of the first stage of report generation.

In some implementations, the first report or portion thereof may be generated using a second template based, at least in part, on a result of application of a condition to information in the first data structure or other results obtained during the first stage. For example, the second template may be applied if it is determined that a signature has obtained, the number of signatures that have been obtained exceed or do not exceed a threshold number, that survey results have been obtained, or if analysis of the survey results indicate that satisfaction of recipients of the survey does not exceed (or does exceed) a specific threshold.

In some implementations, at least a portion of the second template is selected based, at least in part, on application of a condition to the result of the first stage of report generation (or to other data obtained during the first stage of report generation). For example, if the satisfaction of recipients does not exceed a specific threshold, a dissatisfaction template may be selected. As another example, if the satisfaction of the recipients exceeds the threshold, a satisfaction template may be selected. As yet another example, specific field(s) of the second template may be selected based, at least in part, on the result of the first stage. This may be useful, for example, where it is determined in the first stage that a recipient of the report speaks a specific language or has a specific role within an organization, enabling specific fields of the second template to be used to present data or, alternatively, to be suppressed from presentation in the report based on the recipient’s role within their organization or their native language. The portion of the first report may then be generated using the selected portion of the second template.

During the report generation process, additional portions of the first report or additional reports may be generated. In some implementations, the first report generated during the report generation process includes two or more portions. The portions of the report may be generated by the same or different templates. Thus, during execution of a third subset of the set of computer-readable instructions associated with a third stage of report generation, at least a third template can be applied such that one or more additional portions of the report are generated.

In some implementations, two or more reports are generated during the report generation process. Therefore, during execution of a third subset of the set of computer-readable instructions associated with a third stage of report generation, at least a third template may be applied such that a second report is generated.

As described above, a report or portion thereof may be generated based, at least in part, application of a condition to results including data and/or metadata obtained during report generation, or analysis thereof. Generation of additional portions of a report or additional reports may be performed based on results obtained during a prior stage, which may be stored or indicated in the data structure, as described herein. An example method of generating additional portions of the first report or additional reports will be described in further detail below with reference to FIG. 4B.

FIG. 4B shows a process flow diagram 450 illustrating a method of generating an additional report or portion thereof during a multi-stage decision-based report generation process, in accordance with various implementations.

During execution of a third subset of the set of computer-readable instructions associated with a third stage of report generation, the system can apply at least a third template at 452. The third template can include, for example, a database query template, an email template, a customer survey template, a signature document template, or a report generation template.

The system ascertains a result of the third stage of report generation at 454, as described above. The system determines whether the third stage of report generation is successfully completed at 456 based, at least in part, on application of at least a second condition to the result of the third stage of report generation. The first indicator of the data structure associated the set of computer-readable instructions may be updated at 458 such that the first indicator indicates whether the third stage of report generation is successfully completed.

Execution of a fourth subset of the set of computer-readable instructions associated with a fourth stage of the report generation may be initiated at 460 based, at least in part, on a value of the first indicator. During the fourth stage of report generation, the system generates at least a portion of the first report or a second report using at least a fourth template at 462.

Reports including the first report generated during the report generation process may be transmitted to at least one recipient. In some implementations, the recipient of the reports and associated contact information may be identified from the data structure. In other implementations, the recipient may be identified based, at least in part, on a result obtained during a stage of report generation.

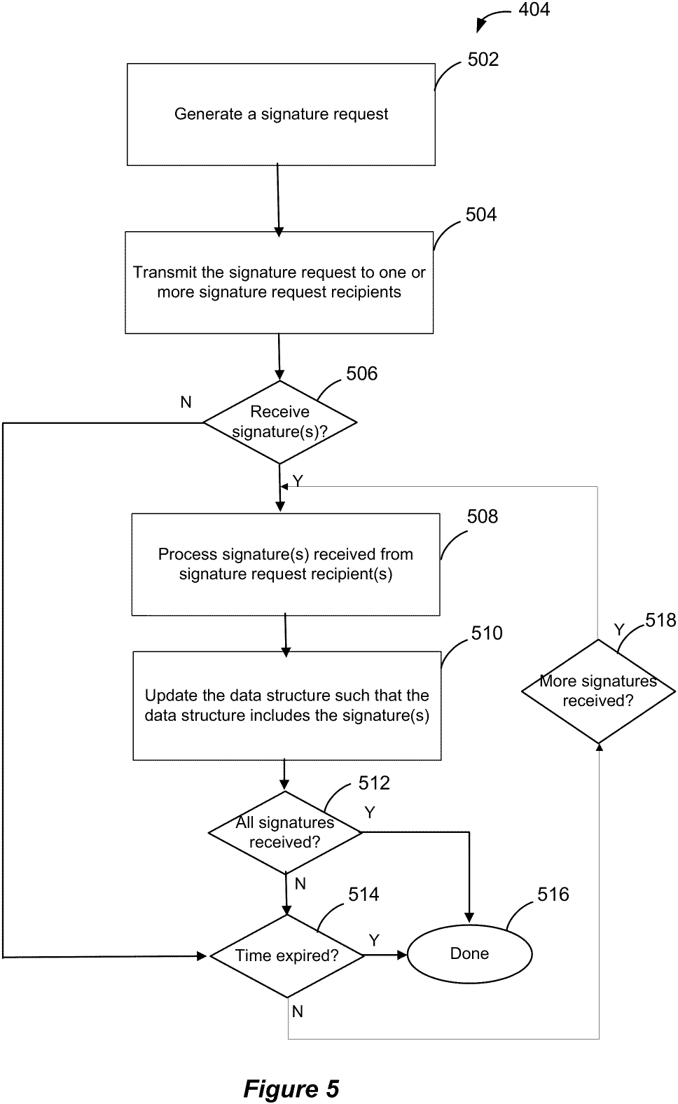

FIG. 5 shows a process flow diagram 404 illustrating a method of obtaining signatures during a portion of a multi-stage decision-based report generation process in accordance with various implementations. The system may generate a signature request at 502 and transmit the signature request to signature request recipient(s) at 504.

In some implementations, the system accesses a parent record of the user for whom a signature is being requested (e.g., user or contact) to obtain communication information such as an email address. The signature request is then transmitted using the obtained communication information.

The system determines whether the signatures were received at 506.

The system processes signature(s) obtained from signature request recipients at 508. As signatures are obtained, a signature entity of the report generation object can be updated to include the signature or associated signed document at 510.

If the system determines that all of the signatures have been received at 510, the process ends at 516. However, if all of the signatures have not been received, the system may determine whether a threshold time has expired at 518. If the threshold time has expired, the process ends at 516. If all signatures have not been received and the threshold time has not expired, the system may proceed to process any further signatures at 518.

The disclosed implementations support a dynamic decision-based multi-stage report generation process. By saving an indication of whether a stage is completed in a report generation data structure, report generation can be halted until a prior stage is successfully completed and can be performed over an extended time period. Moreover, by supporting dynamic, condition-based reporting, report generation can be extended to cover scenarios in which user responses such as signatures or surveys can be obtained and incorporated into reports, as well as used to guide the progression of report generation through multiple stages.

Some but not all of the techniques described or referenced herein are implemented using or in conjunction with a database system. Salesforce.com, inc. is a provider of customer relationship management (CRM) services and other database management services, which can be accessed and used in conjunction with the techniques disclosed herein in some implementations. In some but not all implementations, services can be provided in a cloud computing environment, for example, in the context of a multi-tenant database system. Thus, some of the disclosed techniques can be implemented without having to install software locally, that is, on computing devices of users interacting with services available through the cloud. Some of the disclosed techniques can be implemented via an application installed on computing devices of users.

Information stored in a database record can include various types of data including character-based data, audio data, image data, animated images, and/or video data. A database record can store one or more files, which can include text, presentations, documents, multimedia files, and the like. Data retrieved from a database can be presented via a computing device. For example, visual data can be displayed in a graphical user interface (GUI) on a display device such as the display of the computing device. In some but not all implementations, the disclosed methods, apparatus, systems, and computer program products may be configured or designed for use in a multi-tenant database environment.

The term “multi-tenant database system” generally refers to those systems in which various elements of hardware and/or software of a database system may be shared by one or more customers. For example, a given application server may simultaneously process requests for a great number of customers, and a given database table may store rows of data such as feed items for a potentially much greater number of customers.

An example of a “user profile” or “user’s profile” is a database object or set of objects configured to store and maintain data about a given user of a social networking system and/or database system. The data can include general information, such as name, title, phone number, a photo, a biographical summary, and a status, e.g., text describing what the user is currently doing. Where there are multiple tenants, a user is typically associated with a particular tenant. For example, a user could be a salesperson of a company, which is a tenant of the database system that provides a database service.

The term “record” generally refers to a data entity having fields with values and stored in database system. An example of a record is an instance of a data object created by a user of the database service, for example, in the form of a CRM record about a particular (actual or potential) business relationship or project. The record can have a data structure defined by the database service (a standard object) or defined by a user (custom object). For example, a record can be for a business partner or potential business partner (e.g., a client, vendor, distributor, etc.) of the user, and can include information describing an entire company, subsidiaries, or contacts at the company. As another example, a record can be a project that the user is working on, such as an opportunity (e.g., a possible sale) with an existing partner, or a project that the user is trying to get. In one implementation of a multi-tenant database system, each record for the tenants has a unique identifier stored in a common table. A record has data fields that are defined by the structure of the object (e.g., fields of certain data types and purposes). A record can also have custom fields defined by a user. A field can be another record or include links thereto, thereby providing a parent-child relationship between the records.

Some non-limiting examples of systems, apparatus, and methods are described below for implementing database systems and enterprise level social networking systems in conjunction with the disclosed techniques. Such implementations can provide more efficient use of a database system. For instance, a user of a database system may not easily know when important information in the database has changed, e.g., about a project or client. Such implementations can provide feed tracked updates about such changes and other events, thereby keeping users informed.

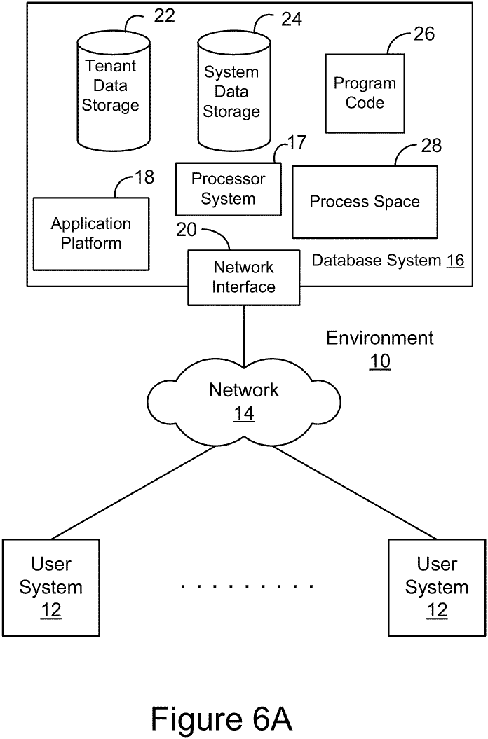

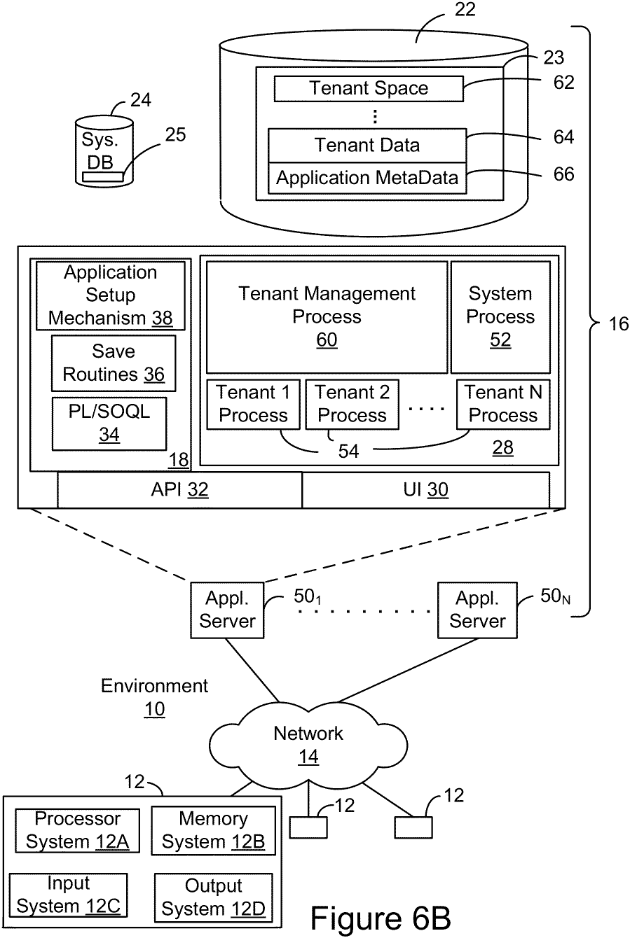

FIG. 6A shows a block diagram of an example of an environment 10 in which an on-demand database service exists and can be used in accordance with some implementations. Environment 10 may include user systems 12, network 14, database system 16, processor system 17, application platform 18, network interface 20, tenant data storage 22, system data storage 24, program code 26, and process space 28. In other implementations, environment 10 may not have all of these components and/or may have other components instead of, or in addition to, those listed above.

A user system 12 may be implemented as any computing device(s) or other data processing apparatus such as a machine or system used by a user to access a database system 16. For example, any of user systems 12 can be a handheld and/or portable computing device such as a mobile phone, a smartphone, a laptop computer, or a tablet. Other examples of a user system include computing devices such as a work station and/or a network of computing devices. As illustrated in FIG. 6A (and in more detail in FIG. 6B) user systems 12 might interact via a network 14 with an on-demand database service, which is implemented in the example of FIG. 6A as database system 16.

An on-demand database service, implemented using system 16 by way of example, is a service that is made available to users who do not need to necessarily be concerned with building and/or maintaining the database system. Instead, the database system may be available for their use when the users need the database system, i.e., on the demand of the users. Some on-demand database services may store information from one or more tenants into tables of a common database image to form a multi-tenant database system (MTS). A database image may include one or more database objects. A relational database management system (RDBMS) or the equivalent may execute storage and retrieval of information against the database object(s). Application platform 18 may be a framework that allows the applications of system 16 to run, such as the hardware and/or software, e.g., the operating system. In some implementations, application platform 18 enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, when a salesperson is using a particular user system 12 to interact with system 16, the user system has the capacities allotted to that salesperson. However, while an administrator is using that user system to interact with system 16, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user’s security or permission level, also called authorization.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. Network 14 can include a TCP/IP (Transfer Control Protocol and Internet Protocol) network, such as the global internetwork of networks often referred to as the Internet. The Internet will be used in many of the examples herein. However, it should be understood that the networks that the present implementations might use are not so limited.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP signals to and from an HTTP server at system 16. Such an HTTP server might be implemented as the sole network interface 20 between system 16 and network 14, but other techniques might be used as well or instead. In some implementations, the network interface 20 between system 16 and network 14 includes load sharing functionality, such as round-robin HTTP request distributors to balance loads and distribute incoming HTTP requests evenly over a plurality of servers. At least for users accessing system 16, each of the plurality of servers has access to the MTS’ data; however, other alternative configurations may be used instead.

In one implementation, system 16, shown in FIG. 6A, implements a web-based CRM system. For example, in one implementation, system 16 includes application servers configured to implement and execute CRM software applications as well as provide related data, code, forms, web pages and other information to and from user systems 12 and to store to, and retrieve from, a database system related data, objects, and Webpage content. With a multi-tenant system, data for multiple tenants may be stored in the same physical database object in tenant data storage 22, however, tenant data typically is arranged in the storage medium(s) of tenant data storage 22 so that data of one tenant is kept logically separate from that of other tenants so that one tenant does not have access to another tenant’s data, unless such data is expressly shared. In certain implementations, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

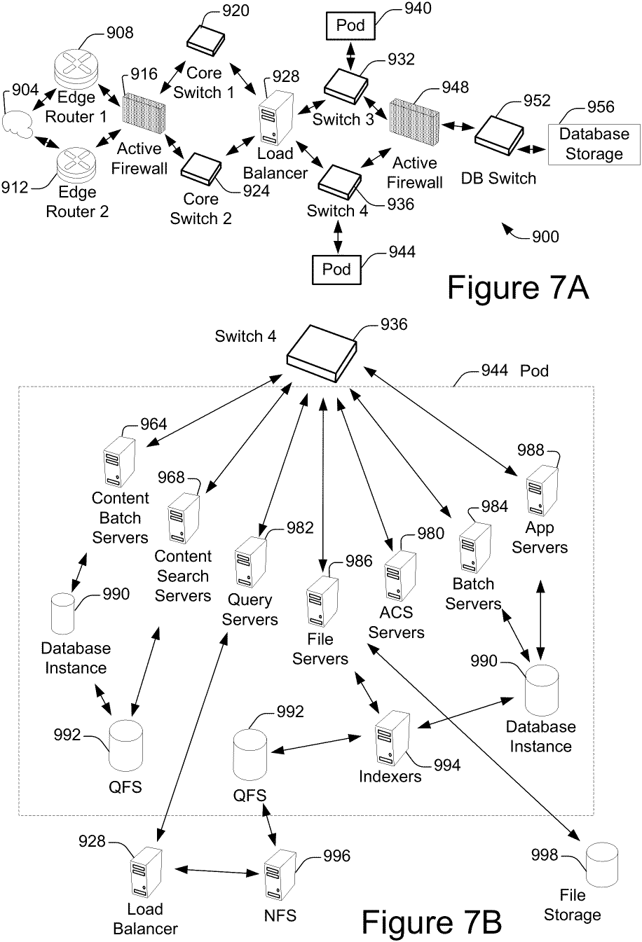

One arrangement for elements of system 16 is shown in FIGS. 7A and 7B, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 6A include conventional, well-known elements that are explained only briefly here. For example, each user system 12 could include a desktop personal computer, workstation, laptop, PDA, cell phone, or any wireless access protocol (WAP) enabled device or any other computing device capable of interfacing directly or indirectly to the Internet or other network connection. The term “computing device” is also referred to herein simply as a “computer”. User system 12 typically runs an HTTP client, e.g., a browsing program, such as Microsoft’s Internet Explorer browser, Netscape’s Navigator browser, Opera’s browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user input devices, such as a keyboard, a mouse, trackball, touch pad, touch screen, pen or the like, for interacting with a GUI provided by the browser on a display (e.g., a monitor screen, LCD display, OLED display, etc.) of the computing device in conjunction with pages, forms, applications and other information provided by system 16 or other systems or servers. Thus, “display device” as used herein can refer to a display of a computer system such as a monitor or touch-screen display, and can refer to any computing device having display capabilities such as a desktop computer, laptop, tablet, smartphone, a television set-top box, or wearable device such Google Glass® or other human body-mounted display apparatus. For example, the display device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

According to one implementation, each user system 12 and all of its components are operator configurable using applications, such as a browser, including computer code run using a central processing unit such as an Intel Pentium® processor or the like. Similarly, system 16 (and additional instances of an MTS, where more than one is present) and all of its components might be operator configurable using application(s) including computer code to run using processor system 17, which may be implemented to include a central processing unit, which may include an Intel Pentium® processor or the like, and/or multiple processor units. Non-transitory computer-readable media can have instructions stored thereon/in, that can be executed by or used to program a computing device to perform any of the methods of the implementations described herein. Computer program code 26 implementing instructions for operating and configuring system 16 to intercommunicate and to process web pages, applications and other data and media content as described herein is preferably downloadable and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any other type of computer-readable medium or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for the disclosed implementations can be realized in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to some implementations, each system 16 is configured to provide web pages, forms, applications, data and media content to user (client) systems 12 to support the access by user systems 12 as tenants of system 16. As such, system 16 provides security mechanisms to keep each tenant’s data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to refer to one type of computing device such as a system including processing hardware and process space(s), an associated storage medium such as a memory device or database, and, in some instances, a database application (e.g., OODBMS or RDBMS) as is well known in the art. It should also be understood that “server system” and “server” are often used interchangeably herein. Similarly, the database objects described herein can be implemented as single databases, a distributed database, a collection of distributed databases, a database with redundant online or offline backups or other redundancies, etc., and might include a distributed database or storage network and associated processing intelligence.

FIG. 6B shows a block diagram of an example of some implementations of elements of FIG. 6A and various possible interconnections between these elements. That is, FIG. 6B also illustrates environment 10. However, in FIG. 6B elements of system 16 and various interconnections in some implementations are further illustrated. FIG. 6B shows that user system 12 may include processor system 12A, memory system 12B, input system 12C, and output system 12D. FIG. 6B shows network 14 and system 16. FIG. 6B also shows that system 16 may include tenant data storage 22, tenant data 23, system data storage 24, system data 25, User Interface (UI) 30, Application Program Interface (API) 32, PL/SOQL 34, save routines 36, application setup mechanism 38, application servers 50₁-50_{N}, system process space 52, tenant process spaces 54, tenant management process space 60, tenant storage space 62, user storage 64, and application metadata 66. In other implementations, environment 10 may not have the same elements as those listed above and/or may have other elements instead of, or in addition to, those listed above.

User system 12, network 14, system 16, tenant data storage 22, and system data storage 24 were discussed above in FIG. 6A. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 6B, system 16 may include a network interface 20 (of FIG. 6A) implemented as a set of application servers 50, an application platform 18, tenant data storage 22, and system data storage 24. Also shown is system process space 52, including individual tenant process spaces 54 and a tenant management process space 60. Each application server 50 may be configured to communicate with tenant data storage 22 and the tenant data 23 therein, and system data storage 24 and the system data 25 therein to serve requests of user systems 12. The tenant data 23 might be divided into individual tenant storage spaces 62, which can be either a physical arrangement and/or a logical arrangement of data. Within each tenant storage space 62, user storage 64 and application metadata 66 might be similarly allocated for each user. For example, a copy of a user’s most recently used (MRU) items might be stored to user storage 64. Similarly, a copy of MRU items for an entire organization that is a tenant might be stored to tenant storage space 62. A UI 30 provides a user interface and an API 32 provides an application programmer interface to system 16 resident processes to users and/or developers at user systems 12. The tenant data and the system data may be stored in various databases, such as one or more Oracle® databases.

Application platform 18 includes an application setup mechanism 38 that supports application developers’ creation and management of applications, which may be saved as metadata into tenant data storage 22 by save routines 36 for execution by subscribers as one or more tenant process spaces 54 managed by tenant management process 60 for example. Invocations to such applications may be coded using PL/SOQL 34 that provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes, which manage retrieving application metadata 66 for the subscriber making the invocation and executing the metadata as an application in a virtual machine.

Each application server 50 may be communicably coupled to database systems, e.g., having access to system data 25 and tenant data 23, via a different network connection. For example, one application server 50₁ might be coupled via the network 14 (e.g., the Internet), another application server 50_{N-1} might be coupled via a direct network link, and another application server 50_{N} might be coupled by yet a different network connection. Transfer Control Protocol and Internet Protocol (TCP/IP) are typical protocols for communicating between application servers 50 and the database system. However, it will be apparent to one skilled in the art that other transport protocols may be used to optimize the system depending on the network interconnect used.

In certain implementations, each application server 50 is configured to handle requests for any user associated with any organization that is a tenant. Because it is desirable to be able to add and remove application servers from the server pool at any time for any reason, there is preferably no server affinity for a user and/or organization to a specific application server 50. In one implementation, therefore, an interface system implementing a load balancing function (e.g., an F5 Big-IP load balancer) is communicably coupled between the application servers 50 and the user systems 12 to distribute requests to the application servers 50. In one implementation, the load balancer uses a least connections algorithm to route user requests to the application servers 50. Other examples of load balancing algorithms, such as round robin and observed response time, also can be used. For example, in certain implementations, three consecutive requests from the same user could hit three different application servers 50, and three requests from different users could hit the same application server 50. In this manner, by way of example, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user’s personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user’s data might be separate from other users’ data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain implementations, user systems 12 (which may be client systems) communicate with application servers 50 to request and update system-level and tenant-level data from system 16 that may involve sending one or more queries to tenant data storage 22 and/or system data storage 24. System 16 (e.g., an application server 50 in system 16) automatically generates one or more SQL statements (e.g., one or more SQL queries) that are designed to access the desired information. System data storage 24 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In certain implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

FIG. 7A shows a system diagram of an example of architectural components of an on-demand database service environment 900, in accordance with some implementations. A client machine located in the cloud 904, generally referring to one or more networks in combination, as described herein, may communicate with the on-demand database service environment via one or more edge routers 908 and 912. A client machine can be any of the examples of user systems 12 described above. The edge routers may communicate with one or more core switches 920 and 924 via firewall 916. The core switches may communicate with a load balancer 928, which may distribute server load over different pods, such as the pods 940 and 944. The pods 940 and 944, which may each include one or more servers and/or other computing resources, may perform data processing and other operations used to provide on-demand services. Communication with the pods may be conducted via pod switches 932 and 936. Components of the on-demand database service environment may communicate with a database storage 956 via a database firewall 948 and a database switch 952.

As shown in FIGS. 7A and 7B, accessing an on-demand database service environment may involve communications transmitted among a variety of different hardware and/or software components. Further, the on-demand database service environment 900 is a simplified representation of an actual on-demand database service environment. For example, while only one or two devices of each type are shown in FIGS. 7A and 7B, some implementations of an on-demand database service environment may include anywhere from one to many devices of each type. Also, the on-demand database service environment need not include each device shown in FIGS. 7A and 7B, or may include additional devices not shown in FIGS. 7A and 7B.

Moreover, one or more of the devices in the on-demand database service environment 900 may be implemented on the same physical device or on different hardware. Some devices may be implemented using hardware or a combination of hardware and software. Thus, terms such as “data processing apparatus,” “machine,” “server” and “device” as used herein are not limited to a single hardware device, but rather include any hardware and software configured to provide the described functionality.

The cloud 904 is intended to refer to a data network or combination of data networks, often including the Internet. Client machines located in the cloud 904 may communicate with the on-demand database service environment to access services provided by the on-demand database service environment. For example, client machines may access the on-demand database service environment to retrieve, store, edit, and/or process information.

In some implementations, the edge routers 908 and 912 route packets between the cloud 904 and other components of the on-demand database service environment 900. The edge routers 908 and 912 may employ the Border Gateway Protocol (BGP). The BGP is the core routing protocol of the Internet. The edge routers 908 and 912 may maintain a table of IP networks or ‘prefixes’, which designate network reachability among autonomous systems on the Internet.

In one or more implementations, the firewall 916 may protect the inner components of the on-demand database service environment 900 from Internet traffic. The firewall 916 may block, permit, or deny access to the inner components of the on-demand database service environment 900 based upon a set of rules and other criteria. The firewall 916 may act as one or more of a packet filter, an application gateway, a stateful filter, a proxy server, or any other type of firewall.

In some implementations, the core switches 920 and 924 are high-capacity switches that transfer packets within the on-demand database service environment 900. The core switches 920 and 924 may be configured as network bridges that quickly route data between different components within the on-demand database service environment. In some implementations, the use of two or more core switches 920 and 924 may provide redundancy and/or reduced latency.

In some implementations, the pods 940 and 944 may perform the core data processing and service functions provided by the on-demand database service environment. Each pod may include various types of hardware and/or software computing resources. An example of the pod architecture is discussed in greater detail with reference to FIG. 7B.

In some implementations, communication between the pods 940 and 944 may be conducted via the pod switches 932 and 936. The pod switches 932 and 936 may facilitate communication between the pods 940 and 944 and client machines located in the cloud 904, for example via core switches 920 and 924. Also, the pod switches 932 and 936 may facilitate communication between the pods 940 and 944 and the database storage 956.

In some implementations, the load balancer 928 may distribute workload between the pods 940 and 944. Balancing the on-demand service requests between the pods may assist in improving the use of resources, increasing throughput, reducing response times, and/or reducing overhead. The load balancer 928 may include multilayer switches to analyze and forward traffic.

In some implementations, access to the database storage 956 may be guarded by a database firewall 948. The database firewall 948 may act as a computer application firewall operating at the database application layer of a protocol stack. The database firewall 948 may protect the database storage 956 from application attacks such as structure query language (SQL) injection, database rootkits, and unauthorized information disclosure.

In some implementations, the database firewall 948 may include a host using one or more forms of reverse proxy services to proxy traffic before passing it to a gateway router. The database firewall 948 may inspect the contents of database traffic and block certain content or database requests. The database firewall 948 may work on the SQL application level atop the TCP/IP stack, managing applications’ connection to the database or SQL management interfaces as well as intercepting and enforcing packets traveling to or from a database network or application interface.

In some implementations, communication with the database storage 956 may be conducted via the database switch 952. The multi-tenant database storage 956 may include more than one hardware and/or software components for handling database queries. Accordingly, the database switch 952 may direct database queries transmitted by other components of the on-demand database service environment (e.g., the pods 940 and 944) to the correct components within the database storage 956.

In some implementations, the database storage 956 is an on-demand database system shared by many different organizations. The on-demand database service may employ a multi-tenant approach, a virtualized approach, or any other type of database approach. On-demand database services are discussed in greater detail with reference to FIGS. 7A and 7B.

FIG. 7B shows a system diagram further illustrating an example of architectural components of an on-demand database service environment, in accordance with some implementations. The pod 944 may be used to render services to a user of the on-demand database service environment 900. In some implementations, each pod may include a variety of servers and/or other systems. The pod 944 includes one or more content batch servers 964, content search servers 968, query servers 982, file servers 986, access control system (ACS) servers 980, batch servers 984, and app servers 988. Also, the pod 944 includes database instances 990, quick file systems (QFS) 992, and indexers 994. In one or more implementations, some or all communication between the servers in the pod 944 may be transmitted via the switch 936.

The content batch servers 964 may handle requests internal to the pod. These requests may be long-running and/or not tied to a particular customer. For example, the content batch servers 964 may handle requests related to log mining, cleanup work, and maintenance tasks.

The content search servers 968 may provide query and indexer functions. For example, the functions provided by the content search servers 968 may allow users to search through content stored in the on-demand database service environment.

The file servers 986 may manage requests for information stored in the file storage 998. The file storage 998 may store information such as documents, images, and basic large objects (BLOBs). By managing requests for information using the file servers 986, the image footprint on the database may be reduced.

The query servers 982 may be used to retrieve information from one or more file systems. For example, the query system 982 may receive requests for information from the app servers 988 and then transmit information queries to the NFS 996 located outside the pod.

The pod 944 may share a database instance 990 configured as a multi-tenant environment in which different organizations share access to the same database. Additionally, services rendered by the pod 944 may call upon various hardware and/or software resources. In some implementations, the ACS servers 980 may control access to data, hardware resources, or software resources.

In some implementations, the batch servers 984 may process batch jobs, which are used to run tasks at specified times. Thus, the batch servers 984 may transmit instructions to other servers, such as the app servers 988, to trigger the batch jobs.

In some implementations, the QFS 992 may be an open source file system available from Sun Microsystems® of Santa Clara, California. The QFS may serve as a rapid-access file system for storing and accessing information available within the pod 944. The QFS 992 may support some volume management capabilities, allowing many disks to be grouped together into a file system. File system metadata can be kept on a separate set of disks, which may be useful for streaming applications where long disk seeks cannot be tolerated. Thus, the QFS system may communicate with one or more content search servers 968 and/or indexers 994 to identify, retrieve, move, and/or update data stored in the network file systems 996 and/or other storage systems.

In some implementations, one or more query servers 982 may communicate with the NFS 996 to retrieve and/or update information stored outside of the pod 944. The NFS 996 may allow servers located in the pod 944 to access information to access files over a network in a manner similar to how local storage is accessed.

In some implementations, queries from the query servers 922 may be transmitted to the NFS 996 via the load balancer 928, which may distribute resource requests over various resources available in the on-demand database service environment. The NFS 996 may also communicate with the QFS 992 to update the information stored on the NFS 996 and/or to provide information to the QFS 992 for use by servers located within the pod 944.

In some implementations, the pod may include one or more database instances 990. The database instance 990 may transmit information to the QFS 992. When information is transmitted to the QFS, it may be available for use by servers within the pod 944 without using an additional database call.

In some implementations, database information may be transmitted to the indexer 994. Indexer 994 may provide an index of information available in the database 990 and/or QFS 992. The index information may be provided to file servers 986 and/or the QFS 992.

In some implementations, one or more application servers or other servers described above with reference to FIGS. 7A and 7B include a hardware and/or software framework configurable to execute procedures using programs, routines, scripts, etc. Thus, in some implementations, one or more of application servers 50₁-50_{N} of FIG. 7B can be configured to initiate performance of one or more of the operations described above by instructing another computing device to perform an operation. In some implementations, one or more application servers 50₁-50_{N} carry out, either partially or entirely, one or more of the disclosed operations. In some implementations, app servers 988 of FIG. 7B support the construction of applications provided by the on-demand database service environment 900 via the pod 944. Thus, an app server 988 may include a hardware and/or software framework configurable to execute procedures to partially or entirely carry out or instruct another computing device to carry out one or more operations disclosed herein. In alternative implementations, two or more app servers 988 may cooperate to perform or cause performance of such operations. Any of the databases and other storage facilities described above with reference to FIGS. 6A, 6B, 7A and 7B can be configured to store lists, articles, documents, records, files, and other objects for implementing the operations described above. For instance, lists of available communication channels associated with share actions for sharing a type of data item can be maintained in tenant data storage 22 and/or system data storage 24 of FIGS. 7A and 7B. By the same token, lists of default or designated channels for particular share actions can be maintained in storage 22 and/or storage 24. In some other implementations, rather than storing one or more lists, articles, documents, records, and/or files, the databases and other storage facilities described above can store pointers to the lists, articles, documents, records, and/or files, which may instead be stored in other repositories external to the systems and environments described above with reference to FIGS. 6A, 6B, 7A and 7B.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of the implementations claimed.

It should be understood that some of the disclosed implementations can be embodied in the form of control logic using hardware and/or computer software in a modular or integrated manner. Other ways and/or methods are possible using hardware and a combination of hardware and software.

Any of the disclosed implementations may be embodied in various types of hardware, software, firmware, and combinations thereof. For example, some techniques disclosed herein may be implemented, at least in part, by computer-readable media that include program instructions, state information, etc., for performing various services and operations described herein. Examples of program instructions include both machine code, such as produced by a compiler, and files containing higher-level code that may be executed by a computing device such as a server or other data processing apparatus using an interpreter. Examples of computer-readable media include, but are not limited to: magnetic media such as hard disks, floppy disks, and magnetic tape; optical media such as flash memory, compact disk (CD) or digital versatile disk (DVD); magneto-optical media; and hardware devices specially configured to store program instructions, such as read-only memory (ROM) devices and random access memory (RAM) devices. A computer-readable medium may be any combination of such storage devices.

Any of the operations and techniques described in this application may be implemented as software code to be executed by a processor using any suitable computer language such as, for example, Java, C++ or Perl using, for example, object-oriented techniques. The software code may be stored as a series of instructions or commands on a computer-readable medium. Computer-readable media encoded with the software/program code may be packaged with a compatible device or provided separately from other devices (e.g., via Internet download). Any such computer-readable medium may reside on or within a single computing device or an entire computer system, and may be among other computer-readable media within a system or network. A computer system or computing device may include a monitor, printer, or other suitable display for providing any of the results mentioned herein to a user.

While various implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

What is claimed is:

1. A system comprising:
a database system implemented using a server system, the database system configurable to cause:
initiating execution of a set of computer-readable instructions configurable to generate a report;
during execution of a first subset of the set of computer-readable instructions associated with a first stage of report generation, applying at least a first template;
ascertaining a result of the first stage of report generation;
determining whether the first stage of report generation is successfully completed based, at least in part, on application of a first condition to the result of the first stage of report generation;
updating a first indicator of a data structure associated with the set of computer-readable instructions such that the first indicator indicates whether the first stage of report generation is successfully completed;
initiating execution of a second subset of the set of computer-readable instructions associated with a second stage of the report generation based, at least in part, on a value of the first indicator; and
during the second stage of report generation, generating at least a portion of a first report using at least a second template.

2. The method of claim 1, further comprising:
during execution of a third subset of the set of computer-readable instructions associated with a third stage of report generation, applying at least a third template such that one or more additional portions of the report are generated.

3. The method of claim 1, further comprising:
during execution of a third subset of the set of computer-readable instructions associated with a third stage of report generation, applying at least a third template such that a second report is generated.

4. The method of claim 1, further comprising:
obtaining a configuration of at least one of: the first condition, one or more operations of the first stage, or one or more operations of the second stage; and
storing the configuration in association with the set of computer-readable instructions.

5. The method of claim 1, the method further comprising:
selecting at least a portion of the second template based, at least in part, on the result of the first stage of report generation;
wherein generating the portion of the first report is performed using the selected portion of the second template.

6. The method of claim 1, wherein determining whether the first stage of report generation is successfully completed comprises:
determining whether at least a first signature has successfully been obtained via the first template; and
updating the data structure such that the data structure indicates whether the first signature has been successfully obtained.

7. The method of claim 1, further comprising:
providing the data structure via an application programming interface (API) corresponding to the second subset of the set of computer-readable instructions, the first indicator including a stage identifier identifying a stage of the report generation.

8. A computing system, comprising:
a processor; and
a memory, the computing device configurable to cause:
initiating execution of a set of computer-readable instructions configurable to generate a report;
during execution of a first subset of the set of computer-readable instructions associated with a first stage of report generation, applying at least a first template;
ascertaining a result of the first stage of report generation;
determining whether the first stage of report generation is successfully completed based, at least in part, on application of a first condition to the result of the first stage of report generation;
updating a first indicator of a data structure associated with the set of computer-readable instructions such that the first indicator indicates whether the first stage of report generation is successfully completed;
initiating execution of a second subset of the set of computer-readable instructions associated with a second stage of the report generation based, at least in part, on a value of the first indicator; and
during the second stage of report generation, generating at least a portion of a first report using at least a second template.

9. The computing system of claim 8, the database system further configurable to cause:
during execution of a third subset of the set of computer-readable instructions associated with a third stage of report generation, applying at least a third template such that one or more additional portions of the report are generated.

10. The computing system of claim 8, the database system further configurable to cause:
during execution of a third subset of the set of computer-readable instructions associated with a third stage of report generation, applying at least a third template such that a second report is generated.

11. The computing system of claim 8, the database system further configurable to cause:
obtaining a configuration of at least one of: the first condition, one or more operations of the first stage, or one or more operations of the second stage; and
storing the configuration in association with the set of computer-readable instructions.

12. The computing system of claim 8, the database system further configurable to cause:
selecting at least a portion of the second template based, at least in part, on the result of the first stage of report generation;
wherein generating the portion of the first report is performed using the selected portion of the second template.

13. The computing system of claim 8, wherein determining whether the first stage of report generation is successfully completed comprises:
determining whether at least a first signature has successfully been obtained via the first template; and
updating the data structure such that the data structure indicates whether the first signature has been successfully obtained.

14. The computing system of claim 8, the database system further configurable to cause:
providing the data structure via an application programming interface (API) corresponding to the second subset of the set of computer-readable instructions, the first indicator including a stage identifier identifying a stage of the report generation.

15. A computer program product comprising computer-readable program code capable of being executed by one or more processors when retrieved from a non-transitory computer-readable medium, the program code comprising computer-readable instructions configurable to cause:
initiating execution of a set of computer-readable instructions configurable to generate a report;
during execution of a first subset of the set of computer-readable instructions associated with a first stage of report generation, applying at least a first template;
ascertaining a result of the first stage of report generation;
determining whether the first stage of report generation is successfully completed based, at least in part, on application of a first condition to the result of the first stage of report generation;
updating a first indicator of a data structure associated with the set of computer-readable instructions such that the first indicator indicates whether the first stage of report generation is successfully completed;
initiating execution of a second subset of the set of computer-readable instructions associated with a second stage of the report generation based, at least in part, on a value of the first indicator; and
during the second stage of report generation, generating at least a portion of a first report using at least a second template.

16. The computer program product of claim 15, the program code comprising computer-readable instructions further configurable to cause:
during execution of a third subset of the set of computer-readable instructions associated with a third stage of report generation, applying at least a third template such that one or more additional portions of the report are generated.

17. The computer program product of claim 15, the program code comprising computer-readable instructions further configurable to cause:
during execution of a third subset of the set of computer-readable instructions associated with a third stage of report generation, applying at least a third template such that a second report is generated.

18. The computer program product of claim 15, the program code comprising computer-readable instructions further configurable to cause:
obtaining a configuration of at least one of: the first condition, one or more operations of the first stage, or one or more operations of the second stage; and
storing the configuration in association with the set of computer-readable instructions.

19. The computer program product of claim 15, the program code comprising computer-readable instructions further configurable to cause:
selecting at least a portion of the second template based, at least in part, on the result of the first stage of report generation;
wherein generating the portion of the first report is performed using the selected portion of the second template.

20. The computer program product of claim 15, wherein determining whether the first stage of report generation is successfully completed comprises:
determining whether at least a first signature has successfully been obtained via the first template; and
updating the data structure such that the data structure indicates whether the first signature has been successfully obtained.
